(19) United States
(12) Patent Application Publication
(10) Pub. No.: US 2005/0264396 A1
(43) Pub. Date: Dec. 1, 2005

(54) Machine security system having remote access code management

(75) Inventors: Robert Ahern Horkavi, Dunlap, IL (US); Gary Lee Spadin, Chillicothe, IL (US); Steven Wayne O'Neal, Bartonville, IL (US); Michael David Staub, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar, Inc.

(21) Appl. No.: 10/855,574

(22) Filed: May 28, 2004

(51) Int. Cl. H04Q 1/00; G05B 19/00

(52) U.S. Cl. 340/5.28; 340/5.6

(57) ABSTRACT

A security system for a work machine has a controller operatively disposed on the work machine that includes a memory with a list of access codes stored in the memory. The security system also has an input device in communication with the controller. The input device is configured to receive an identification code and to transfer the identification code to the controller. The security system further has an off-board system disposed at a location remote from the work machine and configured to receive a change to the list of access codes and to store the change in at least one removable memory device. The security system further has a memory reader in communication with the controller. The memory reader is configured to read the at least one removable memory device and to transfer the change from the at least one removable memory device to the memory of the controller.

### TECHNICAL FIELD

The present disclosure relates generally to a machine security system, and more particularly, to a machine security system having remote access code management.

### BACKGROUND

Work machines such as, for example, wheel loaders, track type tractors, articulated trucks, excavators, and other types of machinery are valuable property and often include security systems aimed at reducing theft or unauthorized use of the work machines. These security systems may include electronic keys provided to operators of the work machine that enable operation during a particular time of day or for a particular time duration.

Typically, a machine security system interacts with a starter to start an engine of a work machine in response to an identification code associated with the electronic key. The identification code is compared to a list of access codes contained in a memory of the work machine. When the code from the electronic key matches one of the codes on the list of access codes, operation of the work machine is permitted. Different identification codes may be given to different operators, allowing them different access times or time periods.

Fleet managers, with responsibility for a number of work machines, may need to periodically update and/or replace the list of access codes maintained on a particular work machine. Updating of access code lists may include adding access codes to the list, removing access codes from the list, or modifying the access rights associated with a particular access code.

U.S. Pat. No. 6,522,251 (the '251 patent) issued to Menne et al. on Feb. 18, 2003 describes a machine security system having updatable access code lists. The '251 patent describes updating the list of access codes with a service tool connected to the work machine. The service tool may be used to directly configure the access key list. The '251 patent also describes connecting the work machine security system with a remote data facility through a communication path such as a satellite connection to receive a message containing modifications to an access key list or a completely new list.

Although the machine security system of the '251 patent may provide adequate theft protection for the work machine, the machine security system may be difficult and time consuming to update. The system of the '251 patent lacks the ability to make similar updates to the access codes of multiple work machines simultaneously or automatically. Each machine must be updated individually.

The present disclosure is directed to overcoming one or more of the problems set forth above.

### SUMMARY OF THE INVENTION

In one aspect, the present disclosure is directed to a security system for a work machine that includes a controller operatively disposed on the work machine and including a memory with a list of access codes stored in the memory. The security system also includes an input device operatively disposed on the work machine and in communication with the controller. The input device is configured to receive an identification code and to transfer the identification code to the controller. The security system further includes an off-board system disposed at a location remote from the work machine, configured to receive a change to the list of access codes, and configured to store the change in at least one removable memory device. The security system further includes a memory reader operatively disposed on the work machine and in communication with the controller. The memory reader is configured to transfer the change from the at least one removable memory device to the memory of the controller to update the list of access codes stored on the memory of the controller.

In another aspect, the present disclosure is directed to a security system for a work machine. The security system includes a controller operatively disposed on the work machine and having a memory with a list of access codes stored in the memory. The security system also includes an input device operatively disposed on the work machine, in communication with the controller, configured to receive an identification code, and configured to transfer the identification code to the controller. The security system further includes an off-board system disposed at a location remote from the work machine, configured to receive a change to the list of access codes, and configured to receive input indicative of work machines targeted for the change. The security system further includes a communication module operatively disposed on the work machine and configured to wirelessly communicate with the off-board system. The off-board system automatically distributes the change to the targeted work machines via the communication module to update the list of access codes stored on the memory of the controller.

In yet another aspect, the present disclosure is directed to a method of updating a security system on a work machine. The method includes receiving a list of access codes in a memory of the work machine and receiving a change to the list of access codes at a location remote from the work machines. The method also includes storing the change in a removable memory device and reading the removable memory device with a memory reader located on the work machine. The method further includes transferring the change to the memory of the work machine to update the list of access codes.

In another aspect, the present disclosure is directed to a method of of updating a security system on a plurality of work machines. The method includes receiving a list of access codes in a memory of each of the plurality of work machines and creating a change to the list of access codes at a location remote from the work machines. The method also includes indicating which ones of the plurality of work machines the change should be applied to. The method further includes automatically distributing the change to the indicated ones of the plurality of work machines.

### BRIEF DESCRIPTION OF THE DRAWINGS

FIG. 1 is a schematic illustration of a security system according to an exemplary disclosed embodiment;

FIG. 2 is a flow chart showing a method of operating a security system according to an exemplary disclosed embodiment;

FIG. 3 is a flow chart showing a method of operating a security system according to an exemplary disclosed embodiment; and

FIG. 4 is a flow chart showing a method of operating a security system according to an exemplary disclosed embodiment.

### DETAILED DESCRIPTION

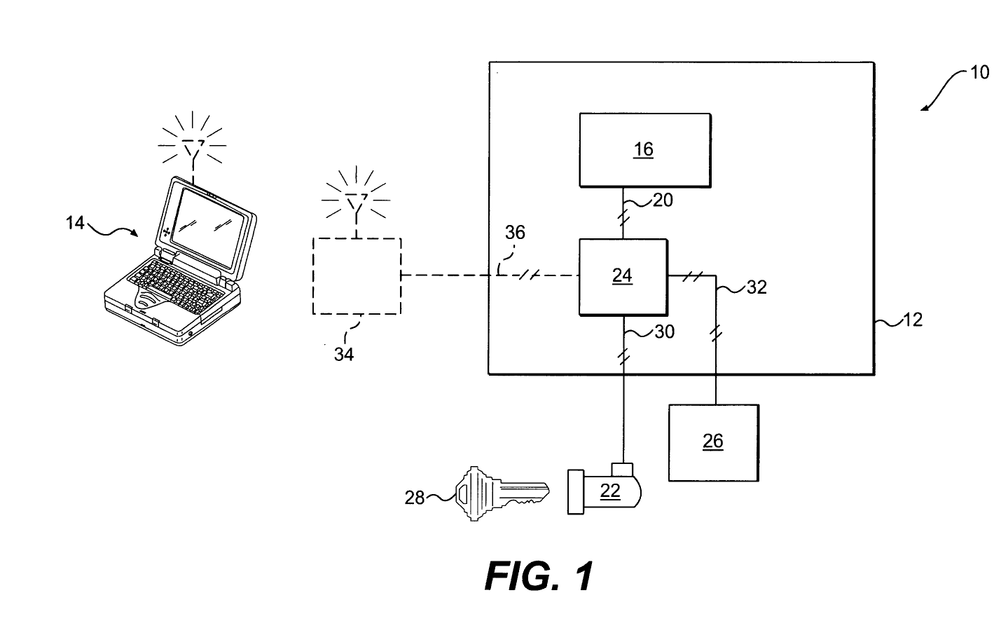

FIG. 1 illustrates an exemplary security system 10 for a work machine 12 that may include a remote off-board system 14. Work machine 12 may be a fixed or mobile machine that performs some type of operation associated with an industry such as mining, construction, farming, or any other industry known in the art. For example, work machine 12 may be an earth moving machine, a generator set, a pump, a marine vessel, an aircraft, or any other suitable operation-performing work machine. Work machine 12 may include a power source 16 in communication with a controller 24.

Power source 16 may be configured to produce a power output at a range of output speeds and torques. Power source 16 may be an engine such as, for example, a diesel engine, a gasoline engine, a natural gas engine, or any other suitable engine. Power source 16 may also be another source of power such as, for example, a fuel cell, a power storage device, or any other source of power known in the art.

Controller 24 may be in communication with power source 16 via a communication line 20. Controller 24 may include an input device 22 and a memory reader 26. It is also contemplated that controller 24, input device 22, and memory reader 26 may be integrated as a single unit.

Input device 22 may include a means for receiving an identification code entered by an operator of work machine 12 such as, for example, a switch configured to receive an encoded key 28 having magnetic information or a memory chip, a keypad allowing the identification code to be manually entered by an operator, a data port allowing communication with a service tool or a computer having the identification code, an antenna allowing reception of the identification code from a remote location, a scanner configured to read an encoded indicia, or any other configuration that can receive the identification code. A code, for the purposes of the present disclosure, may include a configuration of letters, numbers, symbols, pulses, voltage levels, bar codes or other indicia, signals, magnetic fields, sound or light waves, and other configurations that may represent assigned meanings. The identification code may take the form of either or both of human readable information and machine readable information. The identification code may correspond with a particular operator, a particular access level, a particular access time, a particular access time period, or any other suitable access parameter known in the art. Input device 22 may be in communication with controller 24 via a communication line 30.

Controller 24 may include any means for storing and comparing information and controlling an operating parameter of work machine 12, such as a memory, one or more data storage devices, a central processing unit, or any other components that may be used to perform tasks associated with running an application. Furthermore, although aspects of the present disclosure may be described generally as being stored in memory, one skilled in the art will appreciate that this includes being stored in or read from types of computer program products or computer-readable media such as computer chips and secondary storage devices, including hard disks, floppy disks, optical media, CD-Rom, or other forms of RAM or ROM. Controller 24 may also contain components such as, for example, mechanical or hydro-mechanical devices. Various other known circuits may be associated with controller 24, including power supply circuitry, signal-conditioning circuitry, solenoid driver circuitry, communication circuitry, and other appropriate circuitry.

Controller 24 may be in communication with power source 16 via communication line 20 and may be configured to control one or more features and/or functions of power source 16 in response to the identification code. Controller 24 may be configured to receive the identification code entered through input device 22 and to compare the code with a list of access codes stored in a memory of controller 24. Controller 24 may further be configured to grant access to particular functions and/or features of work machine 12 if the identification code matches one of the access codes on the list or to deny access to particular functions and/or features of work machine 12 if the entered code does not match one of the access codes on the list. For example, controller 24 may be in communication with a starter motor (not shown) of power source 16 and configured to supply power to the starter motor if the identification code matches one of the access codes. Controller 24 may also block power to the starter motor if the identification code does not match one of the access codes.

Memory reader 26 may be in communication with controller 24 via a communication line 32 and may be any means for reading data from a removable memory device such as a disk drive, an indicia scanner, a magnetic media reader, an optical media reader, or any other means known in the art. A removable memory device may include a magnetic storage device such as a floppy disk, an optical storage device such as a CD-ROM, a solid state storage device such as a memory card, or another storage device known in the art.

A communication module 34 may be included and may communicate with controller 24 via a communication line 36. It is also contemplated that communication module 34, input device 22, controller 24, and memory reader 26 may be integrated as a single unit. Communication module 34 may include any device that is configured to facilitate remote communications between controller 24 and off-board system 14. Communication module 34 may include hardware and/or software that enables communication module 34 to send and/or receive data messages through wireless communication. As shown in FIG. 1, communication module 34 may include one or more antennae or sensors for facilitating wireless communications. The wireless communications may include satellite, cellular, infrared, and any other type of wireless communications that enables controller 24 to wirelessly exchange information with off-board system 14. It is also contemplated that work machine 12 may include both memory reader 26 and communication module 34.

Off-board system 14 may represent one or more computing systems associated with a business entity corresponding to work machine 12, such as a manufacturer, dealer, retailer, owner, or any other entity that generates, maintains, sends, and/or receives information associated with work machine 12. The one or more computing systems may include a work station, a personal digital assistant, a laptop, a mainframe, and other computing systems known in the art. Off-board system 14 may include means for writing data onto a removable memory device. The means for writing may include, for example, a disk drive, a CD writer, a bar-code generator, or other means known in the art. Alternately, off-board system 14 may communicate with communication module 34 via telephonic and/or electronic mediums such as wireless telephone, pages, text-messages, electronic mail, etc.

Off-board system 14 may be configured to generate and store data in one or more removable memory devices to be distributed to multiple work machines 12 within a single fleet. Alternately, off-board system 14 may be configured to generate and send the data via electronic or telephonic messages to one or more work machines 12 operating within a single fleet. This data may contain information such as, for example, changes to a list of access codes and new lists of access codes. This data may be generated by a manager of a construction company, a foreman of a construction site, a rental store employee, or anyone else with appropriate authority. This data may be common to multiple work machines 12 and yet may only require generation once. This data, generated during a single generation session, may be sent to multiple work machines 12 without the person responsible for generating the data having to address each work machine 12 individually.

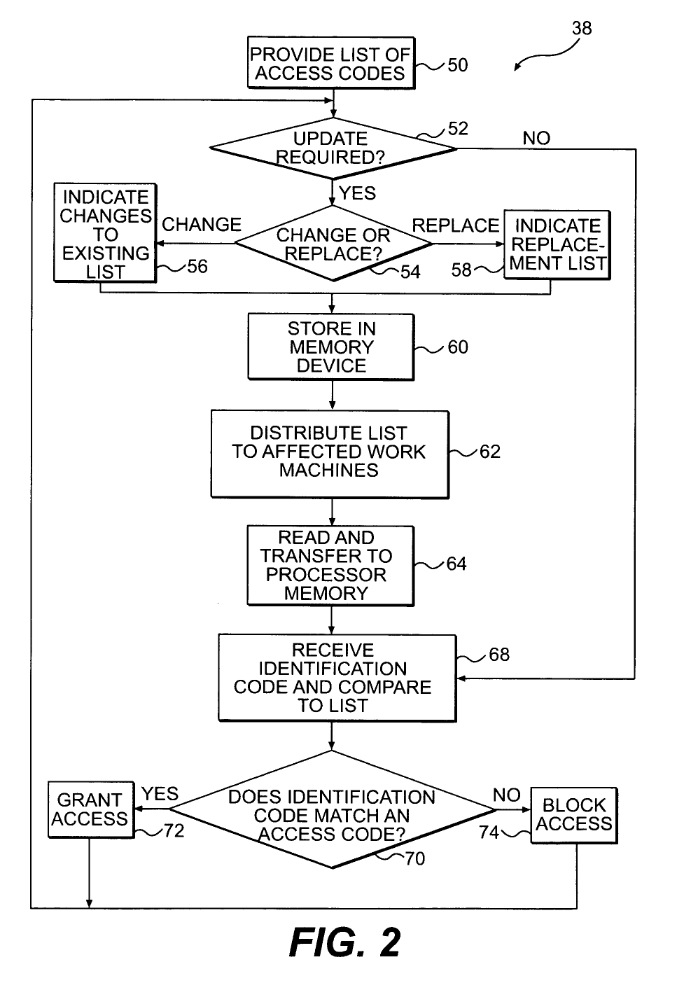

FIGS. 2, 3, and 4 illustrate flow charts 38, 40, and 42 of exemplary methods of operating security system 10. These figures will be described in detail below.

### INDUSTRIAL APPLICABILITY

The disclosed security system may be applicable anywhere it is advantageous to control access code lists for one or more work machines from a remote location. Security system 10 may reduce the difficulty and time associated with updating security access code lists for a fleet of work machines 12 by allowing a single code-generating session to be applied to multiple work machines 12. In this manner, a person with code-generating responsiblities may not need to address individual work machines 12 with separate code-generating sessions. Operations of security system 10 will now be explained.

As illustrated in flow chart 38 of FIG. 2, an initial list of access codes may be provided for each work machine 12 (step 50). During operation of work machine 12, a need may arise to change or replace the existing list of access codes associated with one or more work machines 12 of a particular fleet. A person authorized to generate the access code list may begin an access code generating session by indicating that there is a need to update the existing list of access codes (step 52). If the need to update the existing list of access codes does not exist, security system 10 may be ready to receive an identification code and compare the identification code to the current list of access codes (step 68).

The access code generating session may begin with an indication of whether the need to update includes a change to or a replacement of the existing list of access codes (step 54). If the need includes a change to the existing list of access codes, each of the changes may be entered via off-board system 14 (step 56). These changes to the list of access codes may include deletion of an access code, addition of an access code, or modification of one or more access rights associated with a particular access code. If, however, the need includes replacement of an entire list of access codes, a new list may be created or an existing list selected from available lists stored on off-board system 14 (step 58).

After either changing or replacing the existing list of access codes within off-board system 14, the changes or the replacement list may be stored in one or more removable memory devices (step 60) for parallel distribution to each of work machines 12 in need of the updated access code list (step 62). This task may not require the same person's involvement who generated the code, because it may be carried out simultaneously by each work machine operator during an operator's work shift, during work machine maintenance, or during any other work machine routines. Upon start-up, shut-down, or any other triggering condition of work machine 12, memory reader 26 may be read and the changes to or a replacement of the list of access codes may be transferred to a memory of controller 24 (step 64) to update the existing list of access codes.

Controller 24 may then receive an identification code entered via input device 22 and compare the code with the updated list (step 68) to determine if the entered code matches one of the codes on the updated list (step 70). As described above, if the identification code matches one of the access codes on the updated list, access may be granted to a particular function and/or feature of work machine 12 associated with the particular access code (step 72). If, however, the identification code does not match one of the access codes, access to the particular function and/or feature may be blocked (step 74).

Security system 10 may continue receiving identification codes and granting or blocking access to work machine 12 using the updated list of access codes until an additional update is required. At that time, control may loop back to begin a new code generating session (step 52).

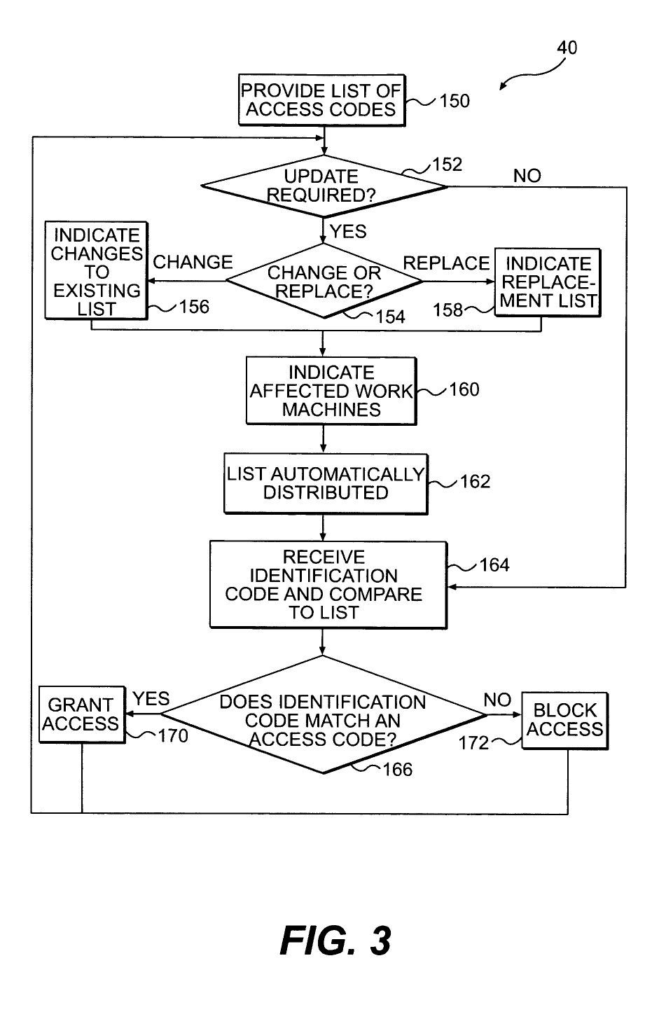

A wireless method of updating the list of access codes is illustrated in flow chart 40 of FIG. 3. Similar to the method of flow chart 38, the wireless method illustrated in chart 40 begins by providing a list of access codes, determining whether an update is required or not, and indicating changes to or a replacement of the list of access codes (steps 150-158). However, once either a change has been made or a replacement list has been created or selected (steps 156 and 158), one or more work machines within a fleet of work machines 12 may be targeted for the update (step 160).

The person responsible for generating the list of access codes may or may not be involved with the update process after the targeting of work machines 12 (step 160) is complete. The changes to or replacement of the access code list may be automatically distributed to the targeted work machines 12 via wireless communication (step 162).

Controller 24 may then receive an identification code entered via input device 22 and compare the code with the updated list (step 164) to determine if the entered code matches one of the codes on the updated list (step 166). As described above, if the identification code matches one of the access codes on the updated list, access may be granted to a particular function and/or feature of work machine 12 associated with the particular access code (step 170). If, however, the identification code does not match one of the access codes, access to the particular function and/or feature may be blocked (step 172).

Security system 10 may continue receiving identification codes and granting or blocking access to work machine 12 using the updated list of access codes until an additional update is required. At that time, control may loop back to begin a new code generating session (step 152).

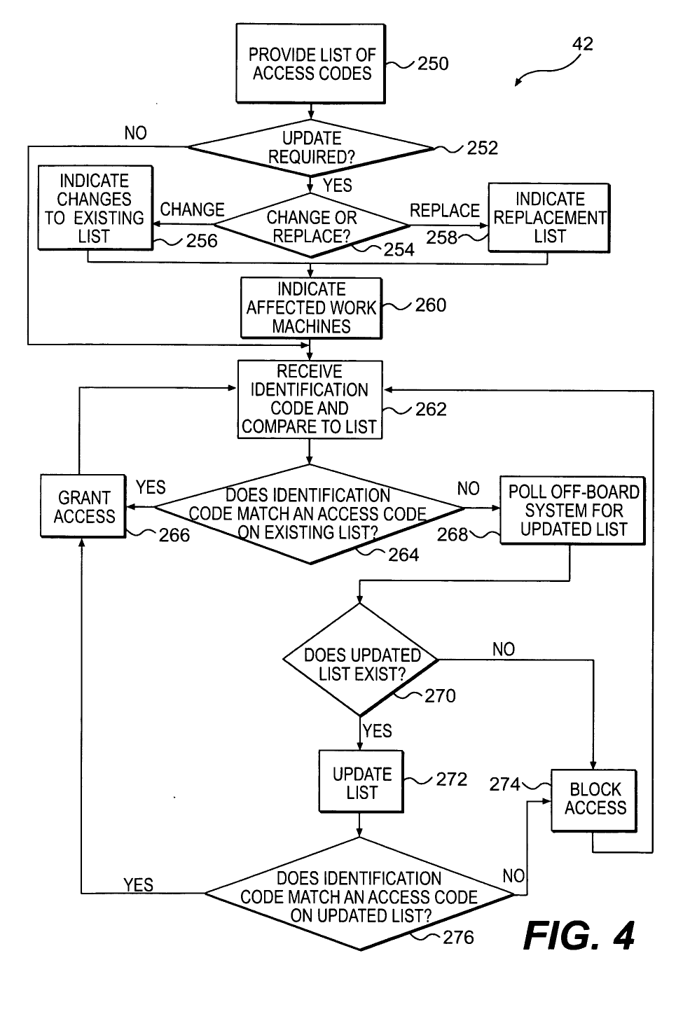

An additional wireless method of updating an exemplary security system 10 is illustrated in flowchart 42 of FIG. 4. Similar to the method of flow chart 40, the wireless method illustrated in chart 42 begins by providing a list of access codes, determining whether an update is required or not, and indicating changes to or a replacement of the list of access codes, and indicating which of the work machines should receive the updated list of access codes (steps 250-260). However, the updated list of access codes may not necessarily be distributed to all of the targeted work machines 12 during the same period of time. The list of access codes may be updated on an as-needed basis.

After particular work machines 12 have been targeted for the updated list of access codes (step 260), security system 10 may be ready to receive the identification code and compare it to the list of access codes that already exists on work machine 12 (step 262). Security system 10 may determine whether or not the entered identification code matches one of the access codes on the existing list of access codes (step 264). If the identification code matches one of the access codes on the existing list, access to work machine 12 may be granted (step 266). However, if the identification code does not match one of the access codes on the existing list, off-board system 14 may be polled for an updated list of access codes (step 268).

Security system 10 may wirelessly communicate with off-board system 14 and determine if an updated list exists (step 270). If an updated list of access codes does exist, it may be transferred to the memory of controller 24 to update the existing list (step 272). If, however, an updated list having the unrecognized code does not exist or is not available for the particular work machine 12 receiving the identification code, access to the particular work machine 12 may be blocked (step 274). After updating the memory of controller 24 with the new list of access codes, security system 10 may determine if the entered identification code matches one of the access codes on the updated list (step 276). If the identification code matches one of the access codes on the updated list, access to work machine 12 may be granted (step 266). If, however, the entered identification code does not match one of the access codes on the updated list, access to work machine 12 may be blocked (step 274). After either granting or blocking access to work machine 12 (steps 266 and 274), security system 10 may be ready to receive a new identification code. The steps of determining if an update is required, indicating changes or replacement, and indicating which machines are targeted (steps 250-260), may be performed at any time, regardless of where security system 10 is in the process of receiving identification codes and granting or blocking access to work machine 12 (steps 262-276).

It will be apparent to those skilled in the art that various modifications and variations can be made to the disclosed security system without departing from the scope of the invention. Other embodiments will be apparent to those skilled in the art from consideration of the specification. It is intended that the specification and examples be considered as exemplary only, with a true scope of the invention being indicated by the following claims and their equivalents.

1. A security system for a work machine, comprising:
a controller operatively disposed on the work machine and including a memory with a list of access codes stored in the memory;
an input device operatively disposed on the work machine and in communication with the controller, the input device configured to receive an identification code and to transfer the identification code to the controller;
an off-board system, disposed at a location remote from the work machine, configured to receive a change to the list of access codes and to store the change in at least one removable memory device; and
a memory reader operatively disposed on the work machine and in communication with the controller, the memory reader configured to read the at least one removable memory device and to transfer the change from the at least one removable memory device to the memory of the controller to update the list of access codes stored on the memory of the controller.

2. The security system of claim 1, wherein at least two of the controller, input device, and memory reader are integrated as a single unit.

3. The security system of claim 1, wherein the change to the list of access codes includes a replacement of the list of access codes.

4. The security system of claim 1, wherein the identification code corresponds to at least one of a work machine operator, an access level, an access time, and an access time period.

5. The security system of claim 1, wherein the controller is configured to compare the identification code with the list of access codes and to grant access to the work machine when the identification code matches one of the access codes on the list of access codes and to block access to the work machine when the identification code does not match one of the access codes on the list of access codes.

6. The security system of claim 1, wherein the change to the list of access codes is stored on a plurality of removable memory devices and configured for parallel distribution to a plurality of work machines.

7. A security system for a work machine, comprising:
a controller operatively disposed on the work machine and including a memory with a list of access codes stored in the memory;
an input device operatively disposed on the work machine and in communication with the controller, the input device configured to receive an identification code and to transfer the identification code to the controller;
an off-board system disposed at a location remote from the work machine, configured to receive a change to the list of access codes, and configured to receive input indicative of work machines targeted for the change; and
a communication module operatively disposed on the work machine and configured to wirelessly communicate with the off-board system, wherein the off-board system automatically distributes the change to the targeted work machines via the communication module to update the list of access codes stored on the memory of the controller.

8. The security system of claim 7, wherein at least two of the controller, input device, and communication module are integrated as a single unit.

9. The security system of claim 7, wherein the change to the list of access codes includes a replacement of the list of access codes.

10. The security system of claim 7, wherein the identification code corresponds to at least one of a work machine operator, an access level, an access time, and an access time period.

11. The security system of claim 7, wherein the controller is configured to compare the identification code with the list of access codes and to grant access to the work machine when the identification code matches one of the access codes on the list of access codes and to deny access to the work machine when the identification code does not match one of the access codes on the list of access codes.

12. The security system of claim 7, wherein the controller is configured to compare the identification code with the list of access codes and to grant access to the work machine when the identification code matches one of the access codes on the list of access codes and to poll the off-board system for an updated list of access codes when the identification code does not match one of the access codes on the list of access codes.

13. The security system of claim 12, wherein the controller is further configured to block access to the work machine when the identification code does not match one of the access codes on the list of access codes and the updated list of access codes is not available.

14. A method of updating a security system for a work machine, the method comprising:
providing a list of access codes in a memory of the work machine;
creating a change to the list of access codes at a location remote from the work machine
storing the change in at least one removable memory device;
reading the removable memory device with a memory reader; and
transferring the change to the memory of the work machine to update the list of access codes.

15. The method of claim 14, wherein the identification code corresponds to at least one of a work machine operator, an access level, an access time, and an access time period.

16. The method of claim 14, wherein the list of access codes is updated upon initiation of a work machine triggering condition.

17. A method of updating a security system for a plurality of work machines, the method comprising:
providing a list of access codes in a memory of each of the plurality of work machines;
generating a change to the list of access codes at a location remote from the plurality of work machines;
providing an indication of which ones of the plurality of work machines the change should be applied to; and
automatically distributing the change to the indicated ones of the plurality of work machines.

18. The method of claim 17, wherein distributing includes wirelessly sending the change to the indicated ones of the plurality of work machines.

19. A method of operating a security system for a work machine, the method comprising:
receiving a list of access codes in a memory of the work machine;
comparing an identification code input to the work machine with the list of access codes;
granting access to the work machine when the identification code matches one of the access codes on the list of access codes; and
polling an off-board system for an updated list of access codes.

20. The method of claim 19, further including blocking access to the work machine when the identification code does not match one of the access codes on the list of access codes and the updated list of access codes is not available.

21. The method of claim 19, wherein the identification code corresponds to at least one of a work machine operator, an access level, an access time, and an access time period.

22. A security system for a work machine, comprising:
a means for storing a list of access codes, the means for storing disposed on the work machine;
a means for receiving an identification code and for transferring the identification code to the means for storing, the means for receiving disposed on the work machine;
an off-board system disposed at a location remote from the work machine, configured to receive a change to the list of access codes, and configured to receive input indicative of work machines targeted for the change; and
a means for wirelessly communicating with the off-board system, wherein the off-board system automatically distributes the change to the targeted work machines via the means for wirelessly communicating.

23. The security system of claim 22, wherein at least two of the means for storing, the means for receiving, and the means for wirelessly communicating are integrated as a single unit.

24. The security system of claim 23, further including a means for comparing the identification code with the list of access codes, for granting access to the work machine when the identification code matches one of the access codes on the list of access codes, and for blocking access to the work machine when the identification code does not match one of the access codes on the list of access codes.

25. The security system of claim 23, further including a means for comparing the identification code with the list of access codes, for granting access to the work machine when the identification code matches one of the access codes on the list of access codes, and for polling the off-board system for an updated list of access codes.

26. The security system of claim 25, wherein the means for comparing and granting is also a means for blocking access to the work machine when the identification code does not match one of the access codes on the list of access codes and the updated list of access codes is not available.

27. The security system of claim 23, wherein the identification code corresponds to at least one of a work machine operator, an access level, an access time, and an access time period.
